(19) United States
(12) Patent Application Publication
(10) Pub. No.: US 2008/0098318 A1
(43) Pub. Date: Apr. 24, 2008

(54) METHOD FOR PROVIDING MENU SCREEN SUITABLE FOR MENUS PROVIDED BY EXTERNAL DEVICE AND IMAGING DEVICE USING THE SAME

(75) Inventors: Dong-young KIM, Seongnam-si (KR); Dae-gyu Bae, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/768,624

(22) Filed: Jun. 26, 2007

Related U.S. Application Data
(60) Provisional application No. 60/852,415, filed on Oct. 18, 2006.

(30) Foreign Application Priority Data
Jan. 4, 2007 (KR) 10-2007-0001080

(51) Int. Cl. G06F 3/048

(52) U.S. Cl. 715/765

(57) ABSTRACT

A method for providing a menu screen suitable for menus provided by a connected external device, and an imaging device using the same, are provided. The method includes acquiring menu name information on names of menus provided by a connected external device; and displaying names of menus provided by the external device based on the acquired menu name information.

### CROSS-REFERENCE TO RELATED APPLICATIONS

This application claims priority from U.S. Provisional Application No. 60/852,415, filed Oct. 18, 2006 in the United States Patent and Trademark Office, and Korean Patent Application No. 10-2007-0001080, filed Jan. 4, 2007 in the Korean Intellectual Property Office, the entire contents of which are incorporated herein by reference.

### BACKGROUND OF THE INVENTION

1. Field of the Invention

Methods and devices consistent with the present invention relate to providing a menu screen, and more particularly, to providing a menu screen showing menus provided by a connected imaging device.

2. Description of the Related Art

FIG. 1 is a diagram illustrating an imaging system conforming to a High Definition Multimedia Interface Consumer Electronics Control (HDMI CEC) standard. Referring to FIG. 1, the imaging system includes a television (TV) 10 and a digital versatile disc recorder (DVDR) 20. The TV 10 and the DVDR 20 are connected with each other according to the HDMI CEC standard. A control signal as well as an image signal is transmitted and received between the TV 10 and the DVDR 20.

The TV 10 may control the operation of the DVDR 20 in response to a user command received via a remote control 15. The TV 10 may display a DVDR-menu screen provided by the DVDR 20, as well as a TV-menu screen provided by the TV.

The TV 10, however, may erroneously display the DVDR-menu screen. Specifically, the TV 10 may display a menu screen showing menus that are not menus desired by the user or a menu screen showing an erroneous menu name. This is because the TV 10 has no information on menus that can be provided by the DVDR 20 and names of the menus.

Accordingly, there is a need for a method for enabling the TV 10 to correctly display a DVDR-menu screen when a user inputs a command to display the DVDR-menu screen, to the TV 10 via the remote control 15.

### SUMMARY OF THE INVENTION

The present invention provides a method for providing a menu screen suitable for menus provided by a connected external device, and an imaging device using the same.

The present invention also provides a method for enabling an imaging device to acquire, in advance, information on menus that can be provided by an external device connected to the imaging device and information on menu names.

According to an aspect of the present invention, there is provided a method for providing a menu screen, comprising acquiring names of menus that can be provided by a connected external device, and displaying names of menus provided by the connected external device using the acquired names.

The acquiring may include requesting the external device to provide a menu information regarding the menus that can be provided by the external device, receiving the menu information from the external device as a response to the request, in response to an input of menu display commands from a user, requesting a menu name information regarding names of menus to be displayed on a display unit, and receiving from the external device the menu name information as a response to the request for the menu name information.

The menu information may be a sum of numbers indicating the menus that can be provided by the external device.

The menu display commands may be commands to display the menus that can be provided by the external device.

The menus that can be provided by the external device may include at least one of a Root menu, a Setup menu, a Contents menu, and a Favorite menu.

The external device may be connected according to the HDMI CEC standard.

According to another aspect of the present invention, there is provided an imaging device comprising a functional block which displays a menu screen on a display unit, an interface for communication with an external device, and a control unit which acquires names of menus that can be provided by the external device connected via the interface, and controlling the functional block to display names of the menus provided by the external device using the acquired names.

The control unit may request, via the interface, the external device to provide a menu information regarding the menus that can be provided by the external device, may receive the menu information from the external device via the interface as a response to the request, may request, via the interface, a menu name information regarding names of menus to be displayed on a display unit in response to an input of menu display commands from a user, and may receive the menu name information from the external device via the interface as a response to the request.

The menu information may be a sum of numbers indicating the menus that can be provided by the external device.

The menu display commands may be commands to display the menus that can be provided by the external device.

The menus that can be provided by the external device may comprise at least one of a Root menu, a Setup menu, a Contents menu, and a Favorite menu.

The external device may be connected according to the HDMI CEC standard.

According to another aspect of the present invention, there is provided a method for providing a menu screen, comprising first-acquiring information on menus that can be provided by a connected external device, and in response to an input of menu display commands from a user, second-acquiring information on names of menus provided by the external device to be displayed on a display unit.

The first-acquiring the information on menus may include requesting the external device to provide a menu information regarding the menus that can be provided by the external device, and receiving the menu information from the external device as a response to the request.

The second-acquiring information on names of menus may include in response to an input of menu display commands from a user, requesting a menu name information regarding names of menus provided by the external device to be displayed on the display unit, and receiving the menu name information from the external device as a response to the request.

According to another aspect of the present invention, there is provided an imaging device comprising an interface for communication with an external device, and a control unit which acquires information on menus that can be provided by the external device connected via the interface, and acquiring information on names of menus provided by the external device to be displayed on a display unit in response to an input of menu display commands from a user.

The control unit may request, via the interface, the external device to provide a menu information regarding the menus that can be provided by the external device, and may receive the menu information from the external device via the interface as a response to the request.

The control unit may request, via the interface, a menu name information regarding names of menus provided by the external device to be displayed on a display unit in response to an input of menu display commands from a user, and may receive the menu name information from the external device via the interface as a response to the request.

According to another aspect of the present invention, there is provided a method for providing a menu screen, comprising first-delivering information on menus that can be provided, to an external device, and when menu display commands from a user are input to the external device, second-delivering, to the external device, information on names of menus to be displayed on a display unit of the external device.

The first-delivering may include receiving, from the external device, a request for a menu information regarding the menus that can be provided, and delivering the menu information to the external device as a response to the request.

The second-delivering may include in response to an input of menu display commands from the user, receiving a request for a menu name information regarding names of menus to be displayed on the display unit of the external device, and delivering the menu name information to the external device as a response to the request.

According to another aspect of the present invention, there is provided an imaging device comprising an interface for communication with an external device, and a control unit which delivers information on menus that can be provided, to an external device via the interface, and delivers, to the external device via the interface, information on names of menus to be displayed on a display unit of the external device when menu display commands from a user are input to the external device.

The control unit may receive, from the external device via the interface, a request for a menu information regarding the menus that can be provided; and may deliver the menu information to the external device via the interface as a response to the request.

The control unit may receive, from the external device via the interface, a request for a menu name information regarding names of menus to be displayed on the display unit of the external device in response to an input of menu display commands from the user, and may deliver the menu name information to the external device via the interface as a response to the request.

### BRIEF DESCRIPTION OF THE DRAWINGS

The above or other aspects of the present invention will be more apparent by describing certain exemplary embodiments of the present invention with reference to the accompanying drawings, in which:

FIG. 1 is a diagram illustrating an imaging system conforming to an HDMI CEC standard;

FIG. 2 is a block diagram illustrating an imaging system to which the present invention can be applied;

FIG. 3 is a flow diagram illustrating a method for providing a menu screen according to an exemplary embodiment of the present invention;

FIG. 4 is a flowchart illustrating a method for providing a menu screen according to another exemplary embodiment of the present invention;

FIG. 5 is a flowchart illustrating a method for providing a menu screen according to still another exemplary embodiment of the present invention; and

FIG. 6 is a flowchart illustrating a method for providing a menu screen according to still another exemplary embodiments of the present invention.

### DETAILED DESCRIPTION OF THE EXEMPLARY EMBODIMENTS OF THE INVENTION

The present invention will be described in greater detail with reference to the accompanying drawings.

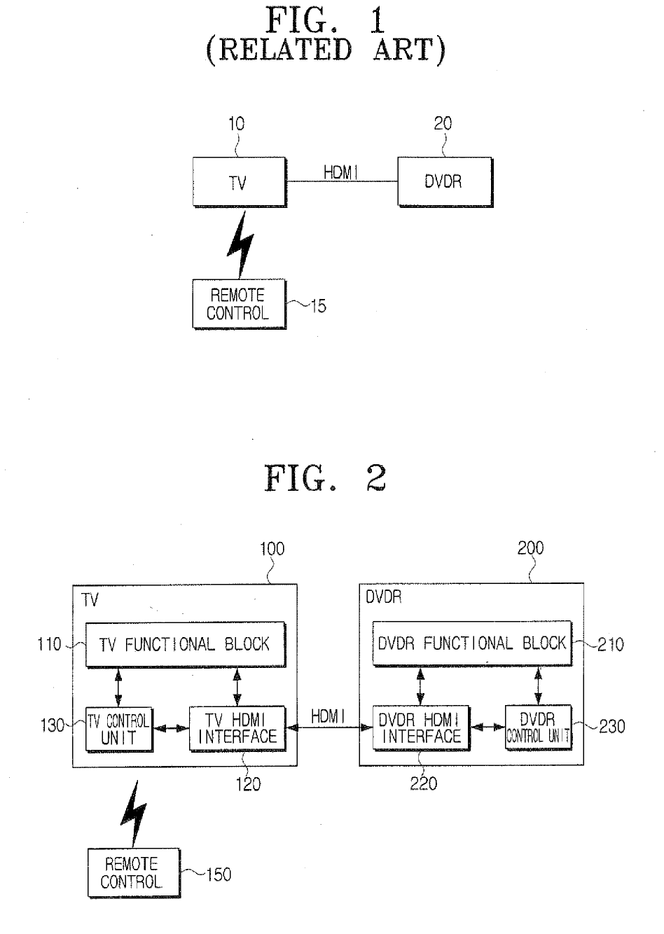

FIG. 2 is a block diagram illustrating an imaging system to which the present invention can be applied. Referring to FIG. 2, an imaging system includes a TV 100 and a DVDR 200. The TV 100 and the DVDR 200 are connected with each other according to an HDMI CEC standard.

Referring to FIG. 2, the TV 100 includes a TV functional block 110, a TV HDMT interface 120, and a TV control unit 130. The TV 100 receives a user command via a remote control 150.

The TV functional block 110 performs signal processing such as decoding, scaling, and the like on a broadcasting signal received from a broadcasting station in a wireless or wired manner and displays it on a display unit to provide a broadcasting screen to the user. The TV functional block 110 may display, on the display unit, an image corresponding to an image signal received from the DVDR 200 via the TV HDMI interface 120 which will be explained below.

Additionally, the TV functional block 110 provides a means for User Interface (UI) to the user by displaying a menu screen on the display unit. The menu screen displayed on the display unit by the TV functional block 110 includes a TV-menu screen provided by the TV 100 itself and a DVDR-menu screen provided by the DVDR 200.

The TV HDMI interface 120 is connected with the DVDR 200 according to the HDMI CEC standard so that an image signal and a message are transmitted and received between the TV 100 and the DVDR 200.

The TV control unit 130 controls the operation of the TV functional block 110 in response to a user command from the remote control 150. Additionally, the TV control unit 130 may control the operation of the DVDR 200 by sending a control command to the DVDR 200 via the TV HDMI interface 120.

The TV control unit 130 also controls the TV functional block 110 so that the TV-menu screen or the DVDR-menu screen is displayed on the display unit. In this case, in order that the DVDR-menu screen is displayed with no error, the TV control unit 130 acquires information on menus provided by the DVDR 200 and information on names of the menus in advance, and controls the DVDR-menu screen displaying operation of the TV functional block 110 using the acquired information.

Referring to FIG. 2, the DVDR 200 includes a DVDR functional block 210, a DVDR HDMI interface 220, and a DVDR control unit 230.

The DVDR functional block 210 performs original functions of the DVDR. Specifically, the DVDR functional block 210 records, in a loaded DVD, a broadcasting signal received from the TV 100 via the DVDR HDMI interface 220, or reads an image signal from the DVD to provide it to the TV 100 via the DVDR HDMI interface 220.

The DVDR HDMI interface 220 is connected with the TV 100 according to the HDMI CEC standard so that an image signal and a message are transmitted or received between the TV 100 and the DVDR 200.

The DVDR control unit 230 controls the operation of the DVDR functional block 210 in response to a control command received from the TV control unit 130 via the DVDR HDMI interface 220.

Additionally, the DVDR control unit 230 sends information on the menus provided by the DVDR 200 and information on names of the menus to the TV 100 via the DVDR HDMI interface 220.

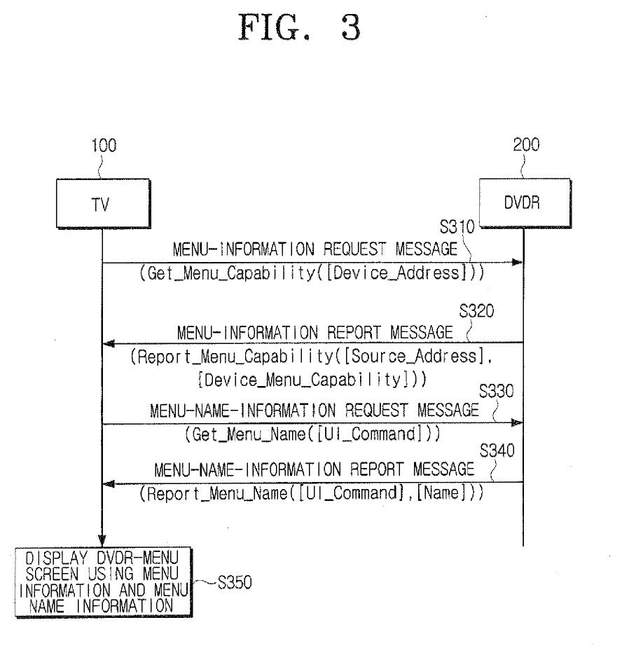

A process of providing the DVDR-menu screen with no error to the display unit of the TV 100 will be described in detail with reference to FIG. 3. FIG. 3 is a flow diagram illustrating a method for providing a menu screen according to an exemplary embodiment of the present invention.

Referring to FIG. 3, the TV control unit 130 sends a menu-information request message “Get_Menu_Capability([Device_Address])” to the DVDR 200 via the TV HDMT interface 120 (S310). The DVDR control unit 230 receives the menu-information request message via the DVDR HDMI interface 220.

The menu-information request message is the message for requesting the information on menus that can be provided by an imaging device corresponding to an address contained in [Device_Address].

The menu-information request message is sent to an imaging device corresponding to an address contained in [Device_Address] among imaging devices connected with the TV 100. In the present exemplary embodiment, [Device Address] is the address of the DVDR 200.

In response to the request for menu information, the DVDR control unit 230 sends a menu-information report message “Report_Menu Capability([Source_Address],[Device_Menu Capability])” to the TV 100 via the DVDR HDMI interface 220 (S320). Accordingly, the TV control unit 130 receives the menu-information report message via the TV HDMI interface 120.

The menu-information report message is the message with which the DVDR 200 receiving the menu-information request message reports the information on the menus that can be provided by the DVDR 200, to the TV 100 sending the menu-information request message.

The menu-information report message is sent to an imaging device corresponding to an address contained in [Source_Address]. In the present exemplary embodiment, [Source Address] is the address of the TV 100.

Additionally, the menu-information report message includes [Device_Menu_Capability] containing the information on the menus that can be provided. If the menus that can be provided by the imaging device are a “Root menu”, a “Setup menu”, a “Contents menu”, and a “Favorite menu” and the menus that can be provided by the DVDR 200 are a “Root menu” and a “Contents menu”, [Device_Menu_Capability] becomes [Root menu, Contents menu].

[Device_Menu_Capability] may be represented by a sum of numbers indicating menus that can be provided. For example, if a number indicating the “Root menu” is “1”, a number indicating the “Setup menu” is “2”, a number indicating the “Contents menu” is “4”, and a number indicating the “Favorite menu” is “8”, and if the menus that can be provided by the DVDR 200 are the “Root menu” and the “Contents menu”, [Device_Menu_Capability] becomes [5] (=1+4).

In this exemplary example, when the DVDR 200 provides all the four menus, [Device_Menu_Capability] is [15] (=1+2+4+8). Thus, [Device_Menu_Capability] can be represented in four bits.

In response to an input of the menu-information report message, the TV control unit 130 sends a menu-name-information request message “Get_Menu_Name([UI_Command])” to the DVDR 200 via the TV HDMI interface 120 (S330). The DVDR control unit 230 receives the menu-name-information request message via the DVDR HDMI interface 220.

The menu-name-information request message is for requesting information on the names of menus to be displayed on the display unit when menu display commands contained in [UI_Command] are input from the user.

If the menus that can be provided by the imaging device are the “Root menu”, the “Setup menu”, the “Contents menu”, and the “Favorite menu” as previously stated, the menu display commands that can be input from the user are a “Root-menu display command”, a “Setup-menu display command”, a “Contents-menu display command”, and a “Favorite-menu display command”.

In an exemplary implementation, the menu display commands contained in [UI_Command] are commands to display the menus contained in [Device_Menu_Capability]. This is because a request for names of menus not contained in [Device_Menu_Capability] is meaningless since the names do not exist.

[UI_Command] may be represented by a string of numbers indicating menu display commands. If a number indicating the “Root-menu display command” is “9”, a number indicating the “Setup-menu display command” is “10”, a number indicating the “Contents-menu display command” is “11”, and a number indicating the “Favorite-menu display command” is “12”, and if the menus that can be provided by the DVDR 200 are the “Root menu” and the “Contents menu”, [UI_Command] is [9, 11] since the menu display commands contained in [UI_Command] are the “Root-menu display command” and the “Contents-menu display command”.

In response to the menu name information request, the DVDR control unit 230 sends a menu-name-information report message “Report_Menu_Name([UI_Command],[Name])” to the TV 100 via the DVDR HDMI interface 220 (S340). The TV control unit 130 receives the menu-name-information report message via the TV HDMI interface 120.

The menu-name-information report message is the message with which the DVDR 200 receiving the menu-name-information request message reports names of menus to be displayed on the display unit, to the TV 100 sending the menu-name-information request message, when the menu display command contained in [UI_Command] is input from the user.

The menu-name-information request message includes [Name] that contains the information on the names of menus to be displayed on the display unit when the menu display command contained in [UI_Command] is input from the user.

If [UI_Command] is [9, 11], the menu name of the DVDR 200 to be displayed on the display unit when the “Root-menu display command” is input from the user is a “DVDR menu”, and the menu name of the DVDR 200 to be displayed when the “Contents menu display command” is input from the user is a “Playback List”, [Name] becomes [DVDR menu, Playback List].

The TV control unit 130 then controls the DVDR-menu screen display operation of the TV functional block 110 using the menu information received in step S420 and the menu name information received in operation S440 (S350).

In the above exemplary example, when the Root-menu display command for the DVDR 200 is input from the user via the remote control 150, the TV control unit 130 controls to display, on the display unit, the menu screen showing the name “DVDR menu” rather than “Root menu”. When the Contents-menu display command for the DVDR 200 is input from the user via the remote control 150, the TV control unit 130 controls to display, on the display unit, the menu screen showing the name “Playback List” rather than “Contents menu”.

When the Setup-menu display command or the Favorite-menu display command for the DVDR 200 is input from the user via the remote control 150, the TV control unit 130 controls not to display the menu screen on the display unit or controls to display, on the display unit, a message indicating that a corresponding menu does not exist.

The process of providing the DVDR-menu screen with no error to the display unit of the TV 100 has been described in detail in the exemplary embodiments.

In the present exemplary embodiment, the menus that can be provided by the imaging device have been assumed to be the “Root menu”, the “Setup menu”, the “Contents menu”, and the “Favorite menu”, but this assumption is only one exemplary example for convenience of illustration. It will be apparent that the present invention may be applied when the imaging device provides other menus.

Further, the “DVDR menu” and “Playback List” are only examples of the menu names and it will be apparent that the present invention may be applied to other menu names.

The imaging system to which the present invention can be applied has been shown in FIG. 2 and described as being the imaging system including the TV 100 and the DVDR 200, but it will be apparent that the present invention may be applied to other imaging systems. Examples of the imaging devices that can constitute the imaging system include a Set Top Box (STB), a DVD Player (DVDP), a Digital Video Recorder (DVR), a Personal Video Recorder (PVR), a Hard Disk Drive (HDD) player, a Blue-lay Disk (BD) player, a BD recorder, a Video Cassette Recorder (VCR), a home theater system, Personal Multimedia Player (PMP), a digital camera, and a digital camcorder, in addition to the TV and the DVDR.

The imaging devices of the imaging system have been described as being connected with each other according to the HDMI CEC standard, but the HDMI CEC standard is only an example for convenience of illustration. It will be apparent that any standards other than the HDMI CEC standard may be applied to the present invention only if they enable the imaging devices to transmit and receive an image signal and a message.

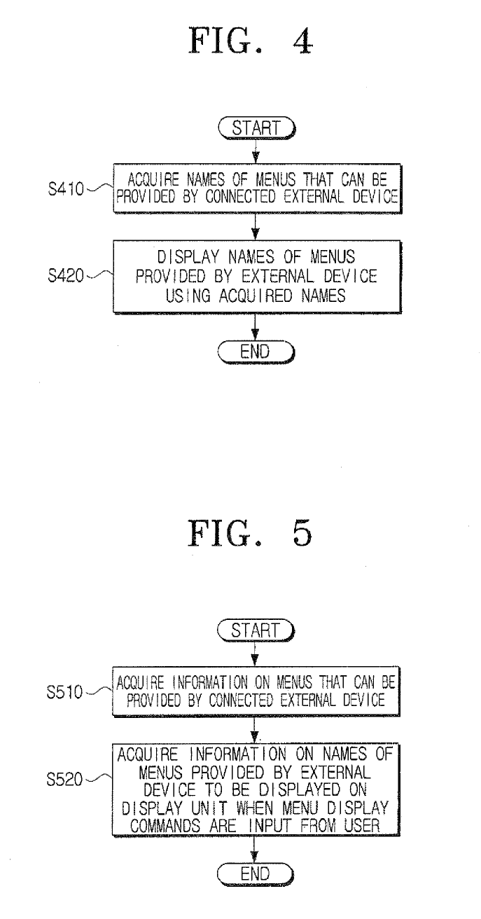

Other exemplary embodiments of the present invention will now be described in detail with reference to FIGS. 4 to 6. Referring to FIG. 4 showing a method for providing a menu screen according to another exemplary embodiment of the present invention, an imaging device acquires names of menus that can be provided by an external device connected with the imaging device (S410) and displays names of the menus provided by the external device using the acquired names (S420).

Referring to FIG. 5 showing a method for providing a menu screen according to still another exemplary embodiment of the present invention, an imaging device acquires information on menus that can be provided by an external device connected with the imaging device (S510), and acquires information on names of menus provided by the external device to be displayed on a display unit when menu display commands are input from a user (S520).

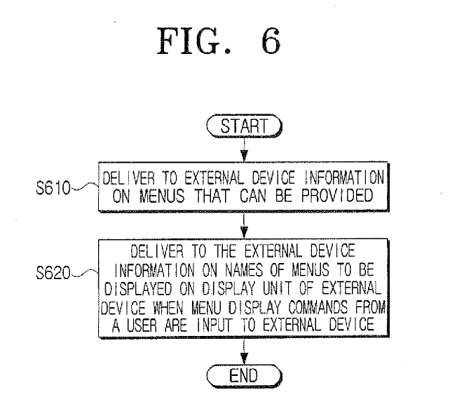

Referring to FIG. 6 showing a method for providing a menu screen according to still another exemplary embodiment of the present invention, an imaging device delivers to an external device information on menus that can be provided (S610), and delivers to the external device information on names of menus to be displayed on a display unit of the external device when menu display commands from a user are input to the external device (S620).

As such, the imaging device can acquire the information on the menus that can be provided by the connected external imaging device and the information on menu names.

As described above, according to the present invention, the imaging device can acquire, in advance, and use the information on the menus that can be provided by the external device connected to the imaging device and the information on the menu names. This allows the imaging device to provide the menu screen suitable for the menus provided by the connected external device, to the user.

Thus, it is possible to prevent the menu screen of the external device showing a menu that is not a menu desired by the user or showing an erroneous menu name from being displayed.

The foregoing embodiments are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for providing a menu screen, the method comprising:
acquiring menu name information on names of menus provided by a external device; and
displaying the names of the menus provided by the external device us based on the acquired menu name information.

2. The method as claimed in claim 1, wherein the acquiring comprises:
requesting the external device to provide a menu information regarding the menus that can be provided by the external device;
receiving the menu information from the external device as a response to the requesting the menu information;
in response to an input of menu display commands from a user, requesting the menu name information regarding names of menus to be displayed on a display unit; and
receiving from the external device the menu name information regarding the names of the menus to be displayed on the display unit as a response to the request for the menu name information regarding the names of the menus to be displayed on the display unit.

3. The method as claimed in claim 2, wherein the menu information is a sum of numbers indicating the menus provided by the external device.

4. The method as claimed in claim 2, wherein the menu display commands are commands to display the menus provided by the external device.

5. The method as claimed in claim 1, wherein the menus provided by the external device comprise at least one of a Root menu, a Setup menu, a Contents menu, and a Favorite menu.

6. The method as claimed in claim 1, wherein the external device is connected according to a High Definition Multimedia Interface Consumer Electronics Control (HDMI CEC) standard.

7. An imaging device comprising:
a functional block which displays a menu screen on a display unit;
an interface for communication with an external device; and
a control unit which acquires menu name information on names of menus provided by the external device connected via the interface, and controls the functional block to display the names of the menus provided by the external device based on the acquired menu name information.

8. The device as claimed in claim 7, wherein the control unit requests, via the interface, the external device to provide a menu information regarding the menus provided by the external device, receives the menu information from the external device via the interface as a response to the request for the menu information, requests, via the interface, the menu name information regarding the names of the menus to be displayed on a display unit in response to an input of menu display commands from a user, and receives the menu name information regarding the names of the menus to be displayed on the display unit from the external device via the interface as a response to the request for the menu name information regarding the names of the menus to be displayed on the display unit.

9. The device as claimed in claim 8, wherein the menu information is a sum of numbers indicating the menus provided by the external device.

10. The device as claimed in claim 8, wherein the menu display commands are commands to display the menus provided by the external device.

11. The device as claimed in claim 7, wherein the menus provided by the external device comprise at least one of a Root menu, a Setup menu, a Contents menu, and a Favorite menu.

12. The device as claimed in claim 7, wherein the external device is connected according to a High Definition Multimedia Interface Consumer Electronics Control standard.

13. A method for providing a menu screen, comprising:
first-acquiring menu information on menus provided by an external device that is connected; and
in response to an input of menu display commands from a user, second-acquiring menu name information on names of menus provided by the external device to be displayed on a display unit.

14. The method as claimed in claim 13, wherein the first-acquiring the information on menus comprises:
requesting the external device to provide the menu information regarding the menus provided by the external device; and
receiving the menu information from the external device as a response to the requesting the menu information.

15. The method as claimed in claim 13, wherein the second-acquiring information on names of menus further comprises:
receiving the menu name information from the external device as a response to the requesting the menu name information.

16. An imaging device comprising:
an interface for communication with an external device; and
a control unit which acquires menu information on menus provided by the external device connected via the interface, and acquires menu name information on names of menus provided by the external device to be displayed on a display unit in response to an input of menu display commands from a user.

17. The device as claimed in claim 16, wherein the control unit requests, via the interface, the external device to provide the menu information regarding the menus provided by the external device, and receives the menu information from the external device via the interface as a response to the request for the menu information.

18. The device as claimed in claim 16, wherein the control unit requests, via the interface, the menu name information regarding the names of the menus provided by the external device to be displayed on the display unit in response to the input of the menu display commands from the user; and receives the menu name information from the external device via the interface as a response to the request for the menu name information.

19. A method for providing a menu screen, comprising:
first-delivering menu information on menus provided, to an external device; and
if menu display commands from a user are input to the external device, second-delivering, to the external device, menu name information on names of menus to be displayed on a display unit of the external device.

20. The method as claimed in claim 19, wherein the first-delivering comprises:
receiving, from the external device, a request for the menu information regarding the menus provided; and
delivering the menu information to the external device as a response to the request for the menu information.

21. The method as claimed in claim 19, wherein the second-delivering comprises:
in response to the input of the menu display commands from the user, receiving a request for the menu name information regarding the names of the menus to be displayed on the display unit of the external device; and
delivering the menu name information to the external device as a response to the request for the menu name information.

22. An imaging device comprising:
an interface for communication with an external device; and
a control unit which delivers menu information on menus provided, to an external device via the interface, and delivers, to the external device via the interface, menu name information on names of menus to be displayed on a display unit of the external device when menu display commands from a user are input to the external device.

23. The device as claimed in claim 22, wherein the control unit receives, from the external device via the interface, a request for the menu information regarding the menus provided; and delivers the menu information to the external device via the interface as a response to the request for the menu information.

24. The device as claimed in claim 22, wherein the control unit receives, from the external device via the interface, a request for the menu name information regarding names of the menus to be displayed on the display unit of the external device in response to the input of the menu display commands from the user, and delivers the menu name information to the external device via the interface as a response to the request for the menu name information.
